(19) United States
(12) Patent Application Publication
(10) Pub. No.: US 2026/0117842 A1
(43) Pub. Date: Apr. 30, 2026

(54) SPLICING GUIDANCE SYSTEMS AND METHODS

(71) Applicant: ContiTech Deutschland GmbH, Hannover (DE)

(72) Inventors: Matheus Alves, Parauapebas (BR); Raphael Amorim, Jundiai (BR); Chad Provence, Douglas, WY (US)

(21) Appl. No.: 18/927,199

(22) Filed: Oct. 25, 2024

(51) Int. Cl. F16G 3/00; B29C 65/00

(52) U.S. Cl. CPC F16G 3/003; B29C 66/855; B29C 66/95

(57) ABSTRACT

The present invention discloses a splicing guidance system for conveyor belts, comprising a splice model library with multiple splice models, a projection device for displaying splice guidance based on a selected splice model, and a controller that receives splicing information, selects a splice model from the library, and instructs the projection device to display the corresponding guidance. This system enables efficient and accurate conveyor belt splicing by providing real-time visual guidance based on the selected splice model, enhancing the overall splicing process and providing suitable conveyor belt performance.

### BACKGROUND

Conveyor belt systems facilitate transfer of material from a source location to a destination location. Conveyor belts are widely used in various applications including mining, luggage systems, grocery stores and the like.

Conveyor belts typically form a continuous loop to create a continuous loop of movement from one location to another. The continuous loop can be created by splicing or connecting belt ends together. Additionally, repairs may be needed that involve replacing sections of the belts that also splice ends together.

Splicing belt ends together is a manual and time consuming process. Further, the splicing is prone to errors.

What is needed are one or more improved techniques for splicing conveyor belts.

### BRIEF DESCRIPTION OF THE DRAWINGS

FIG. 1 is a system 100 in accordance with one or more embodiments.

FIG. 2 is a diagram illustrating a splicing guidance system 200 in accordance with one or more embodiments.

FIG. 3 is a diagram showing guidance 300 for splicing the conveyor belt 216 in accordance with one or more embodiments.

FIG. 4 is a flow diagram illustrating a method 400 of providing guidance for splicing in accordance with one or more embodiments.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, with the understanding that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one, and the singular also includes the plural unless otherwise stated.

The terminology and phraseology used herein is for descriptive purposes and should not be construed as limiting in scope. Language such as “including”, “comprising”, “having”, “containing”, or “involving”, and variations thereof, is intended to be broad and encompass the subject matter listed thereafter, equivalents, and additional subject matter not recited.

Also, as used herein, any references to “one embodiment” or “an embodiment” means that a particular element, feature, structure, or characteristic described in connection with the embodiment is included in at least one embodiment.

The appearances of the phrase “in one embodiment” in various places in the specification are not necessarily referring to the same embodiment.

Conveyor belt systems facilitate transfer of material from a source location to a destination location. Conveyor belts are widely used in various applications including mining, luggage systems, grocery stores and the like.

Conveyor belts typically form a continuous loop to create a continuous loop of movement from one location to another. The continuous loop can be created by splicing or connecting belt ends together.

Additionally, damaged conveyor belts can be repaired by replacing a damaged section of the belt with a new or repair section. This can involve removing a damaged section and reconnecting a remaining belt, also referred to as a choke splice.

Existing systems for guiding conveyor belt splicing operations typically rely on manual measurements and visual inspection to determine the appropriate splicing technique and location. This approach can be time-consuming, error-prone, and may result in inconsistent splicing quality across different splicing operations.

What is needed are one or more improved techniques for splicing conveyor belts.

One or more embodiments are provided that include a conveyor belt splicing guidance system to facilitate conveyor belt splicing.

In some aspects, the techniques described herein relate to a splicing guidance system for a conveyor belt, the system including: a splice model library having a plurality of splice models; a projection device to project guidance for a splice based on a splice model, the guidance is provided in real-time and is visual; and a controller configured to receive splicing information, provide a splice selection to the splice model library, receive the splice model based on the splice selection, develop the guidance based on the splice model and direct the projection device to project the guidance.

In some aspects, the techniques described herein relate to a system, wherein the guidance includes cutting locations.

In some aspects, the techniques described herein relate to a system, wherein the guidance identifies reinforcement cutting locations.

In some aspects, the techniques described herein relate to a system, wherein the guidance identifies adhesion regions.

In some aspects, the techniques described herein relate to a system, wherein the projection device is a laser system in includes one or more lasers that emit light at one or more wavelengths to provide the guidance.

In some aspects, the techniques described herein relate to a system, wherein the plurality of splice models are selectable by belt width and/or thickness.

In some aspects, the techniques described herein relate to a system, wherein the plurality of splice models are selectable by belt composition.

In some aspects, the techniques described herein relate to a system, wherein the plurality of splice models include splice installation information including cover removal.

In some aspects, the techniques described herein relate to a system, wherein the guidance is projected proximate first and second belt ends of the conveyor belt.

In some aspects, the techniques described herein relate to a system, wherein the guidance includes a plurality of wavelengths.

In some aspects, the techniques described herein relate to a system, wherein the projection device aligns with clamping regions proximate a belt splice.

In some aspects, the techniques described herein relate to a system, wherein the controller further generates the guidance based on environmental conditions.

In some aspects, the techniques described herein relate to a method of splicing a conveyor belt, the method including: selecting a splice model from a plurality of splice models; displaying splice guidance based on the selected splice model; cutting the conveyor belt ends according to the displayed guidance; and attaching the belt ends as a splice.

In some aspects, the techniques described herein relate to a method, further including displaying a pattern on the conveyor belt with dashed lines that indicate cutting locations.

In some aspects, the techniques described herein relate to a method, further including displaying alignment shapes as part of the guidance.

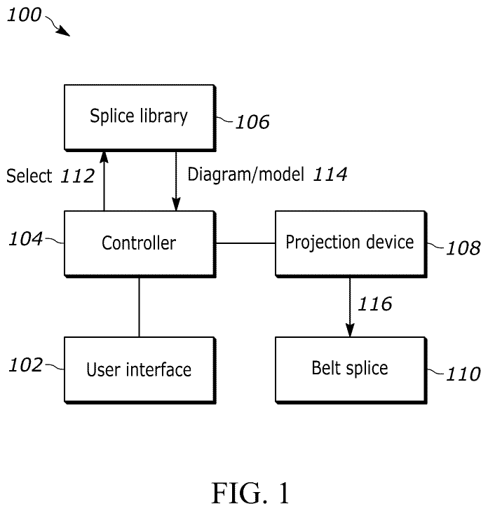

FIG. 1 is a diagram illustrating a splicing guidance system 100 in accordance with one or more embodiments. The system is provided for illustrative purposes and suitable variations are contemplated.

The system 100 includes a user interface 102, a controller 104, a splice library 106, a projection device 108 and operates on a belt splice 110.

The system 100 facilitates connecting first and second belt ends of a conveyor belt and/or replacement sections by projecting real-time visual guidance using a model based on the conveyor belt and environmental conditions.

The user interface 102 can include audio, video, textual and the like inputs and outputs. Splice information can be entered and include, for example, a unique identification, belt model, transverse width, splice length, splice thickness, belt thickness and the like associated with the conveyor belt.

The controller 104 can include one or more processors, a memory, storage, communication interfaces and the like.

The controller 104 provides a splice selection 112 to the splice library 106 based on the splice information. The splice selection 112 can include, for example, the splice identification and/or other information of or derived from the splice information.

The library 106 includes, stores and maintains a plurality of splice diagrams or models for a plurality of splices. The plurality of models include layers, recommended splicing process, cutting locations, cutting depths and the like. The library 106 provides a specific model 114 based on the splice selection 112.

The controller 104 provides guidance based on the model 114 to the projection device 108. The guidance can also be at least partially based on environmental conditions, such as temperature.

The projection device 108 projects guidance for one or more splicing steps as real-time visual guidance for or correlated with the splice model selection 112 from the splice library 106.

The projection device 108 is equipped with one or more lasers and the like to show guidance for current step, cutting locations, cutting depths and the like. The lasers emit light waves, typically with a consistent wavelength and direction for targeting locations on and proximate the belt splice 110. The emitted light can be of a single wavelength or color. The emitted light shows as visible guidance for facilitating splicing of belt ends.

The guidance is projected by the projection device 108 on or about the belt splice 110 and is typically provided as real-time visual guidance. As stated above, the guidance can be in the form of visible or emitted light. The guidance can be provided with varied line thicknesses, line types, selected colors and the like.

The guidance identifies cut locations of the conveyor belt to cut, for example, with belt cutters.

The guidance includes identification of regions of a top cover of the belt to remove for splicing.

The guidance includes identification of clamp locations to clamp and hold the conveyor belt during the splicing.

The guidance includes marking lines and geometric shapes that mark the conveyor belt for cutting and alignment.

The guidance includes adhesion regions that identify where to roughen surfaces and/or adhere belt ends together.

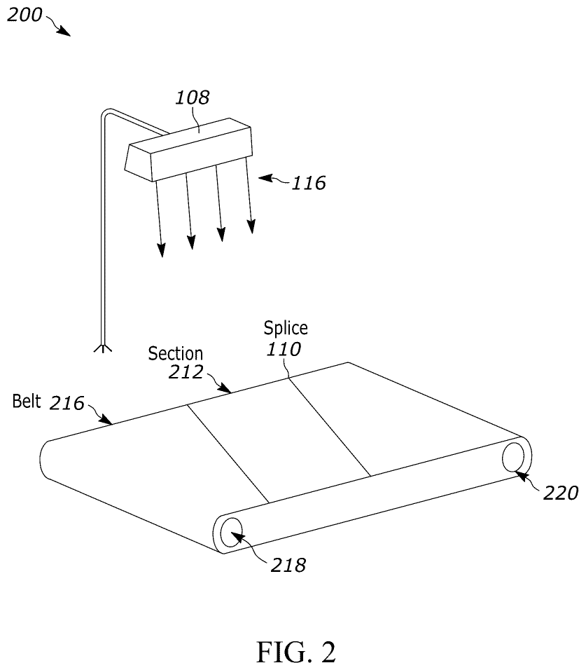

FIG. 2 is a diagram illustrating a splicing guidance system 200 in accordance with one or more embodiments. It is appreciated that suitable variations are contemplated.

The system 200 can be used with or as the system 100 described above.

The system 200 is shown with the projection device 108 and operates on the splice 110 or splices 110 for a replacement section 212 for a conveyor belt 216 formed as an endless belt and includes a first drive/pulley 218 and a second drive/pulley 220. The system 200 can also be utilized for connecting belt ends for belt installation and the like.

The projection device 108 illustrates guidance based on the splice model 116.

In one example, marks or clamp locations are identified by the projection device 108 to facilitate alignment and suitable projection of guidance on the belt and/or proximate the belt splice 110.

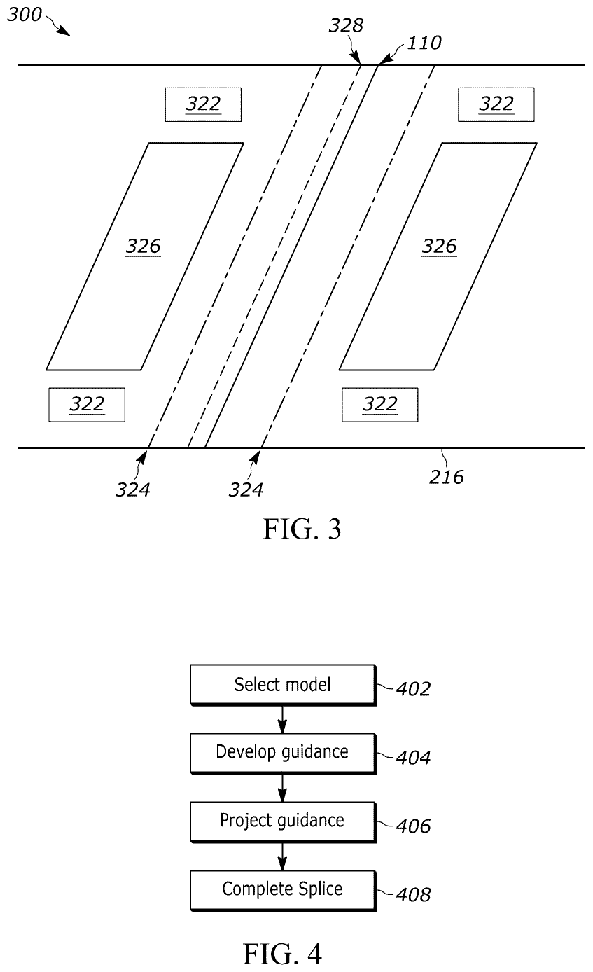

FIG. 3 is a diagram showing guidance 300 for splicing the conveyor belt 216 in accordance with one or more embodiments. It is appreciated that suitable variations are contemplated.

The guidance 300 includes clamp locations 322, cut locations 324, alignment shapes 326, adhesion regions 328 and the like.

The guidance can be provided in the form of colored lasers using a plurality of colors and line types to identify various locations utilized for the splicing or connecting of belt ends.

FIG. 4 is a flow diagram illustrating a method 400 of providing guidance for splicing in accordance with one or more embodiments. It is appreciated that suitable variations are contemplated.

The method 400 can be performed in conjunction with the systems 100 and 200.

A controller 104 selects a guidance diagram model 114 from a library 106 of splice models at 402. The selected model 114 can be selected based on belt width, belt material, belt thickness and the like.

The controller 104 develops guidance for the splice 110 using the selected model at 404.

The projection device 108 projects the guidance onto the belt 216 at 406.

The splice 110 is performed or completed at 408 using the projected guidance. In one example, the splice is performed by a user using belt cutters, belt clamps, adhering tools, vulcanizing presses and the like.

The foregoing description of the embodiments has been provided for purposes of illustration and description. Example embodiments are provided so that this disclosure will be sufficiently thorough and will convey the scope to those who are skilled in the art. Numerous specific details are set forth such as examples of specific components, devices, and methods, to provide a thorough understanding of embodiments of the disclosure but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

Although the terms first, second, third, etc. may be used herein to describe various elements, components, regions, layers and/or sections, these elements, components, regions, layers and/or sections should not be limited by these terms.

These terms may be only used to distinguish one element, component, region, layer or section from another region, layer or section. Terms such as “first”, “second”, and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer”, “beneath”, “below”, “lower”, “above”, “upper”, and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Clause 1. A splicing guidance system for a conveyor belt, the system comprising: a splice model library having a plurality of splice models; a projection device to project guidance for a splice based on a splice model, the guidance is provided in real-time and is visual; and a controller configured to receive splicing information, provide a splice selection to the splice model library, receive the splice model based on the splice selection, develop the guidance based on the splice model and direct the projection device to project the guidance.

Clause 2. The system of clause 1, wherein the guidance includes cutting locations.

Clause 3. The system of any of clauses 1-2, wherein the guidance identifies reinforcement cutting locations.

Clause 4. The system of any of clauses 1-3, wherein the guidance identifies adhesion regions.

Clause 5. The system of any of clauses 1-4, wherein the projection device is a laser system in includes one or more lasers that emit light at one or more wavelengths to provide the guidance.

Clause 6. The system of any of clauses 1-5, wherein the plurality of splice models are selectable by belt width and/or thickness.

Clause 7. The system of any of clauses 1-6, wherein the plurality of splice models are selectable by belt composition.

Clause 8. The system of any of clauses 1-7, wherein the plurality of splice models include splice installation information including cover removal.

Clause 9. The system of any of clauses 1-8, wherein the guidance is projected proximate first and second belt ends of the conveyor belt.

Clause 10. The system of any of clauses 1-9, wherein the guidance comprises a plurality of wavelengths.

Clause 11. The system of any of clauses 1-10, wherein the projection device aligns with clamping regions proximate a belt splice.

Clause 12. The system of any of clauses 1-11, wherein the controller further generates the guidance based on environmental conditions.

Clause 13. A method of splicing a conveyor belt, the method comprising: selecting a splice model from a plurality of splice models; displaying splice guidance based on the selected splice model; cutting the conveyor belt ends according to the displayed guidance; and attaching the belt ends as a splice.

Clause 14. The method of clause 13, further comprising displaying a pattern on the conveyor belt with dashed lines that indicate cutting locations.

Clause 15. The method of clause 14, further comprising displaying alignment shapes as part of the guidance.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A splicing guidance system for a conveyor belt, the system comprising:
a splice model library having a plurality of splice models;
a projection device to project guidance for a splice based on a splice model, the guidance is provided in real-time and is visual; and
a controller configured to receive splicing information, provide a splice selection to the splice model library, receive the splice model based on the splice selection, develop the guidance based on the splice model and direct the projection device to project the guidance.

2. The system of claim 1, wherein the guidance includes cutting locations.

3. The system of claim 1, wherein the guidance identifies reinforcement cutting locations.

4. The system of claim 1, wherein the guidance identifies adhesion regions.

5. The system of claim 1, wherein the projection device is a laser system in includes one or more lasers that emit light at one or more wavelengths to provide the guidance.

6. The system of claim 1, wherein the plurality of splice models are selectable by belt width and/or thickness.

7. The system of claim 1, wherein the plurality of splice models are selectable by belt composition.

8. The system of claim 1, wherein the plurality of splice models include splice installation information including cover removal.

9. The system of claim 1, wherein the guidance is projected proximate first and second belt ends of the conveyor belt.

10. The system of claim 1, wherein the guidance comprises a plurality of wavelengths.

11. The system of claim 1, wherein the projection device aligns with clamping regions proximate a belt splice.

12. The system of claim 1, wherein the controller further generates the guidance based on environmental conditions.

13. A method of splicing a conveyor belt, the method comprising:
selecting a splice model from a plurality of splice models;
displaying splice guidance based on the selected splice model;
cutting the conveyor belt ends according to the displayed guidance; and
attaching the belt ends as a splice.

14. The method of claim 13, further comprising displaying a pattern on the conveyor belt with dashed lines that indicate cutting locations.

15. The method of claim 14, further comprising displaying alignment shapes as part of the guidance.
